(19) United States
(12) Patent Application Publication
(10) Pub. No.: US 2018/0360157 A1
(43) Pub. Date: Dec. 20, 2018

(54) SMART SHOE AND METHOD FOR PROCESSING DATA THEREFOR

(71) Applicant: LG ELECTRONICS INC., Seoul (KR)

(72) Inventors: Woong JEONG, Seoul (KR); Sungkwon JANG, Seoul (KR); Seungyong SHIN, Seoul (KR); Hokyung KA, Seoul (KR); Dongkyu SEO, Seoul (KR)

(73) Assignee: LG ELECTRONICS INC., Seoul (KR)

(21) Appl. No.: 16/062,950

(22) PCT Filed: Dec. 21, 2016
(86) PCT No.: PCT/KR2016/015020

§ 371 Date: Jun. 15, 2018

(30) Foreign Application Priority Data
Jan. 5, 2016 (KR) 10-2016-0001173
Jan. 28, 2016 (KR) 10-2016-0010690

(51) Int. Cl. A43B 3/00; G06F 3/01; G01C 23/00; G01P 15/00; G01C 19/00; G01L 1/00

(52) U.S. Cl. CPC A43B 3/0005; G06F 3/017; G01L 1/005; G01P 15/00; G01C 19/00; G01C 23/00

(57) ABSTRACT

The present specification discloses a smart shoe for detecting a motion and a method for processing motion data detected by the smart shoe, according to the present invention. According to the present invention, one embodiment of the smart shoe comprises a sensor unit including an acceleration sensor, a gyro sensor, and a pressure sensor which is switched according to step-units and senses the pressure of the smart shoe, and a data processing unit for acquiring and processing motion data of the smart shoe on the basis of the sensing data of the sensor unit. Here, the data processing unit removes the step noise of the smart shoe motion data on the basis of the acceleration sensor data and gyro sensor data, which are sensed by the acceleration sensor and the gyro sensor, by referring to the zero velocity data detected from the pressure sensor data sensed the pressure sensor, and filters the motion data, from which the step noise is removed, so as to process the motion data of the smart shoe on the basis of the filtered motion data and a predefined first threshold value.

### TECHNICAL FIELD

The present invention relates to a smart shoe detecting a motion and processing of motion data sensed by the smart shoe.

### BACKGROUND ART

Although a mobile terminal performs the simple communication function only, it is recently developed into a smartphone as a multimedia device equipped with multiple functions so as to perform functions related to production and consumption of contents and the like.

And, a mobile terminal is implemented as a user-wearable item, i.e., a wearable device or the like as well as the smartphone.

Moreover, as a mobile terminal is extended to various things, a study for performing a core function for IoT (Internet of Things) is in progress.

As one of the above mobile terminals, a wearable device is extended to a product (e.g., clothes, shoes, etc.) a user should wear from a device such as a smart watch, a smart glass, a HMD (head mounted display), etc.

Regarding this, a shoe as a wearable device, so-called smart shoe performs a function of analyzing information on wearer's activity and informing the user of prescribed information through a mobile terminal or by itself. In order to perform such a function, sensors are mainly used. However, such sensors cause the power consumption increase of circuits or modules provided to a smart shoe, thereby causing a problem of frequent replacement or failure due to battery consumption. Meanwhile, data sensed based on sensors provided to the related art smart shoe has a problem of failing in accurately sensing, analyzing and distinguishing a motion of the smart shoe wearer. This causes a problem that the wearer's reliability on the smart shoe is lowered.

### DISCLOSURE OF THE INVENTION

### Technical Task

Accordingly, the present invention is directed to substantially obviate one or more problems due to limitations and disadvantages of the related art. One technical task of the present invention is to improve battery efficiency by minimizing power consumption despite collecting and analyzing motion sensing data of a wearer through a smart shoe using a new sensor module.

Another technical task of the present invention is to improve accuracy in comparison with the related art motion sensing algorithm by proposing a motion sensing algorithm based on sensing data collected through the sensor module.

Through the description, further technical task of the present invention is to raise reliability by improving accuracy of data sensed by a smart shoe as well as to resolve the inconvenience according to frequent battery replacements and the like by raising battery efficiency of the smart shoe.

Technical tasks obtainable from the present invention are non-limited by the above-mentioned technical task. And, other unmentioned technical tasks can be clearly understood from the following description by those having ordinary skill in the technical field to which the present invention pertains.

### Technical Solutions

In the present specification, a smart shoe and data processing method thereof according to the present invention are disclosed.

In one technical aspect of the present invention, provided herein is a smart shoe, including a sensor unit including an acceleration sensor, a gyro sensor and a pressure sensor sensing a pressure of the smart shoe by being switched by a step unit and a data processing unit obtaining and processing motion data of the smart shoe based on sensing data of the sensor unit, wherein the data processing unit is configured to remove step noise of the motion data of the smart shoe based on acceleration sensor data sensed through the acceleration sensor and gyro sensor data sensed through the gyro sensor by referring to zero velocity data detected from pressure sensor data sensed through the pressure sensor, filter the step noise removed motion data, and process the motion data of the smart shoe based on the filtered motion data and a predefined first threshold.

In another technical aspect of the present invention, provided herein is a smart shoe system, including a smart shoe including an acceleration sensor, a gyro sensor and a pressure sensor sensing a pressure of the smart shoe by being switched by a step unit and a mobile terminal including a data processing unit receiving sensing data of the smart shoe sensors, the mobile terminal processing motion data of the smart shoe based on the received pressure sensor sensing data, wherein the data processing unit is configured to detect zero velocity data from the pressure sensing data in the received sensing data, remove step noise of moving speed data generated from the acceleration sensor sensing data and the gyro sensor sensing data based on the detected zero velocity data, and obtain motion data of the smart shoe based on the step noise removed moving velocity data.

In further technical aspect of the present invention, provided herein is a method of processing data in a smart shoe, including collecting sensing data from sensors, obtaining motion data from the collected sensing data, detecting zero velocity data of the motion data based on sensing data of a pressure sensor sensing a pressure of the smart shoe by being switched by a step unit among the sensors, removing step noise of the motion data based on the detected zero velocity data, filtering the step noise removed motion data, and processing motion data of the smart shoe based on the filtered motion data and a predefined threshold.

Technical tasks obtainable from the present invention are non-limited by the above-mentioned technical tasks. And, other unmentioned technical tasks can be clearly understood from the following description by those having ordinary skill in the technical field to which the present invention pertains.

### Advantageous Effects

Accordingly, the present invention provides the following effects.

According to at least one of embodiments of the present invention, battery efficiency can be improved by minimizing power consumption despite collecting and analyzing motion sensing data of a wearer through a smart shoe using a new sensor module.

According to at least one of embodiments of the present invention, accuracy in comparison with the related art motion sensing algorithm can be improved by proposing a motion sensing algorithm based on sensing data collected through the sensor module.

According to at least one of embodiments of the present invention, reliability can be raised by improving accuracy of data sensed by a smart shoe and the inconvenience according to frequent battery replacements and the like can be resolved by raising battery efficiency of the smart shoe.

Effects obtainable from the present invention are non-limited by the above mentioned effect. And, other unmentioned effects can be clearly understood from the following description by those having ordinary skill in the technical field to which the present invention pertains.

### DESCRIPTION OF DRAWINGS

FIG. 1 is a block diagram to describe a smart shoe 100 related to the present invention.

FIG. 2 is a cross-sectional diagram of a y-z plane of a smart shoe 100 related to the present invention.

FIG. 3 is a time-series diagram of correspondence to a motion, i.e., a step of a wearer 300 of a smart shoe related to the present invention.

FIG. 4 is a diagram showing distribution of pressure working on a smart shoe 100 related to the present invention.

FIG. 5 is a schematic diagram of an internal structure of human foot bones.

FIG. 6 is a flowchart for a smart shoe 100 related to the present invention.

FIG. 7 is a diagram of a pressure switch 710 and a first circuit unit 751 related to the present invention.

FIG. 8 is a front perspective diagram of a pressure switch module related to the present invention.

FIG. 9A and FIG. 9B are cross-sectional diagrams along an A-A′ direction of FIG. 8.

FIG. 10 is a diagram showing one embodiment of a pressure switch module 700 related to the present invention.

FIG. 11 is a diagram showing several embodiments of a smart shoe 100 related to the present invention.

FIG. 12 is a diagram showing a configuration for smart shoe tracking algorithm according to one embodiment of the present invention.

FIG. 13 is a diagram for one example of a noise-contained tracking data graph according to the present invention.

FIG. 14 is a diagram for one example of a noise-removed tracking data graph according to the present invention.

FIG. 15 is a diagram for one example of a motion data graph for a smart shoe wearer according to the present invention.

FIG. 16 is a diagram of a UX for one example of a service scenario according to the aforementioned present invention.

FIG. 17 is a flowchart of a data processing method in a smart shoe system according to the present invention.

### BEST MODE FOR INVENTION

Description will now be given in detail according to exemplary embodiments disclosed herein, with reference to the accompanying drawings. For the sake of brief description with reference to the drawings, the same or equivalent components may be provided with the same reference numbers, and description thereof will not be repeated. In general, a suffix such as “module” and “unit” may be used to refer to elements or components. Use of such a suffix herein is merely intended to facilitate description of the specification, and the suffix itself is not intended to give any special meaning or function. In the present disclosure, that which is well-known to one of ordinary skill in the relevant art has generally been omitted for the sake of brevity. The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings.

A wearable device that is one of mobile terminals is extended and developed into a product such as user-worn clothing, user-worn shoes and the like from such a device as a smartwatch, smart glasses, HMD (head mounted display) and the like. The shoes shall be named a smart shoe for clarity in the present specification, which will be described in detail later.

The smart shoe may collect motion data according to a motion of a smart shoe wearer and calculate a workrate of the wearer by analyzing the collected motion data. Or, by sending the collected or analyzed motion data to another mobile terminal such as a smartphone, the smart shoe may provide relevant data to a user. With respect to the present invention, analysis of motion data, workrate calculation or the like, relevant data provision and the like may be performed by the smart shoe or through another mobile terminal.

Particularly, a smart shoe can collect or obtain motion data for data acquisition, data processing and the like for activity time, activity distance, activity path and the like of a wearer currently wearing the smart shoe.

The smart shoe uses a motion sensor to sense and collect motion data. Generally, the motion sensor means an acceleration sensor and a gyro sensor. Yet, the motion sensor in the present specification may mean a pressure sensor to be mentioned later or at least two of the acceleration sensor, the gyro sensor and the pressure sensor. Meanwhile, a sensor unit may be configured in the smart shoe as well as the aforementioned sensor(s) despite not mentioned especially. Or, a separate configuration or communication-capable other sensor(s) may be included in the meaning of the motion sensor.

A smart shoe can sense an approximate location of its own through a satellite navigation device such as a GPS (global positioning system), and obtain additional data as well as the location by further referring to data of an acceleration sensor, a gyro sensor and the like. Moreover, the smart shoe may operate wearer's step recognition, a reference of a step unit and the like by measuring speed through a motion sensor. Yet, if the GPS, the acceleration sensor, the gyro sensor and the like continue to be active for the data collection, a battery consumption amount increases. This may put structural restriction on circuit design for a smart shoe or have difficulty in lightening weight of a smart shoe. Moreover, even if a battery is replaceable, it is inconvenience to replace a battery manually and directly each time.

Meanwhile, regarding a workrate of a user (i.e., wearer) wearing a smart shoe, it is important to accurately detect a wearer's step. A related art motion sensor has an error of missing a wearer's step or failing to distinguish the step accurately due to noise generated from a sensor and the like. Yet, if such errors are cumulated, motion data for workrate measurement through a smart shoe and the like may become erroneous due to the cumulated errors. This may affect the reliability on the smart shoe, thereby causing problems.

Therefore, one embodiment of a smart shoe according to the present invention includes a sensor unit including an acceleration sensor, a gyro sensor and a pressure sensor sensing a pressure of the smart shoe by being switched in a unit of step and a data processing unit obtaining and processing motion data of the smart shoe based on sensing data of the sensor unit. Here, the data processing unit removes step noise of motion data of the smart shoe based on acceleration sensor data and gyro sensor data sensed through the acceleration sensor and the gyro sensor by referring to zero velocity data detected from pressure sensor data sensed through the pressure sensor, filers the step noise removed motion data, and processes the motion data of the smart shoe based on the filtered motion data and a predefined first threshold.

One embodiment of a smart shoe system according to the present invention includes a smart shoe including an acceleration sensor, a gyro sensor and a pressure sensor sensing pressure of a smart shoe and a data processing unit receiving sensing data of the smart shoe sensors and processing motion data of the smart shoe based on the received pressure sensor sensing data. Here, the data processing unit detects zero velocity data from the pressure sensor sensing data in the received sensing data, removes step noise of moving velocity data generated from the acceleration sensor sensing data and the gyro sensor sensing data based on the detected zero velocity data, and obtains motion data of the smart shoe based on the step noise removed moving velocity data.

In the above description, the data processing unit may be named various names such as a tracking data processing unit, a sensor data processing unit, a sensor processing unit, a sensor data correcting unit and the like, by which the present invention is non-limited. For clarity, the data processing unit shall be described as named a tracking data processing unit.

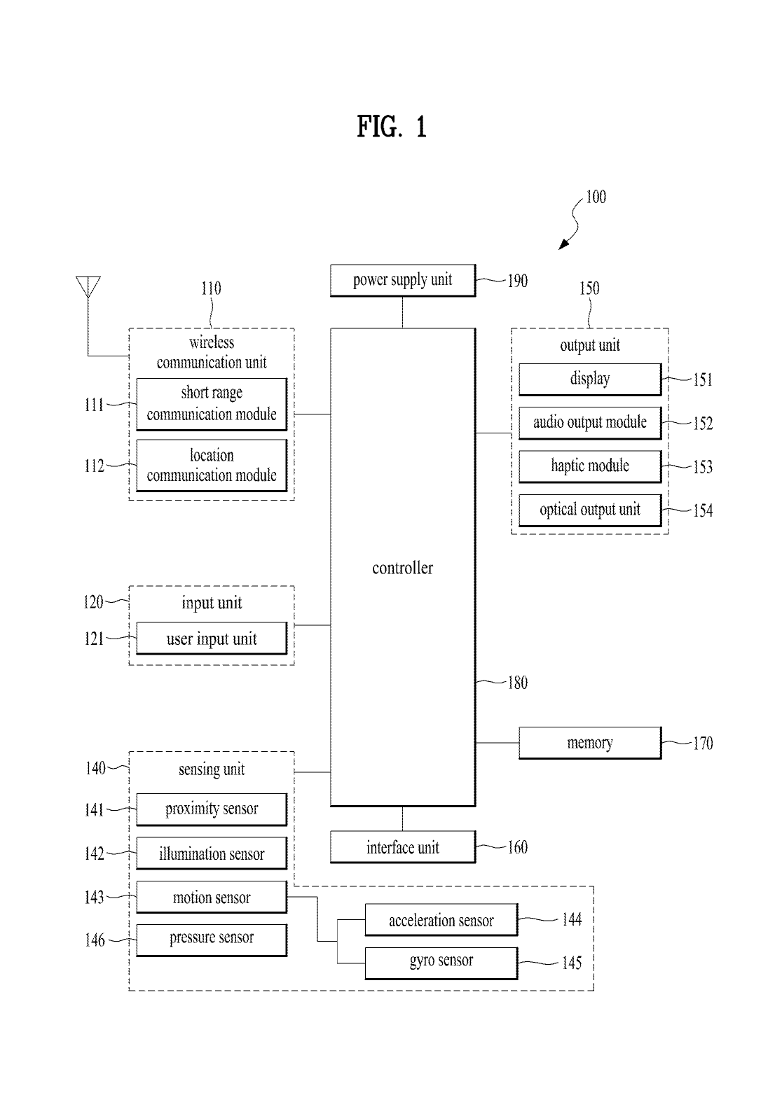

FIG. 1 is a block diagram to describe a smart shoe 100 related to the present invention.

The smart shoe 100 is shown having components such as a wireless communication unit 110, an input unit 120, a sensing unit 140, an output unit 150, an interface unit 160, a memory 170, a controller 180, and a power supply unit 190. It is understood that implementing all of the illustrated components is not a requirement, and that greater or fewer components may alternatively be implemented.

For instance, the wireless communication unit 110 typically includes one or more components which permit wireless communication between the smart shoe 100 and a wireless communication system or network within which the mobile terminal is located. Moreover, the wireless communication unit 110 may include at least one module connecting the smart shoe 100 to one or more networks.

Such a wireless communication unit 110 may include at least one of the short range communication module 111 and the location information module 112. The short range communication module 111 can transmit/receive data by being connected to a mobile terminal by Bluetooth. The location information module 112 plays a role in measuring or sending location information of the smart shoe 100 and may include the concept of being redundant with a motion sensor 143 that will be described later.

The input unit 120 may include a user input unit 121 (e.g., a touch key, a push key (a mechanical key), etc.) for receiving an input of information from a user. Audio or image data collected by the input unit 120 is analyzed and processed as a user's control command. The input unit 120 may play a role in receiving an input of an ON/OFF function of activating or deactivating a function of the smart shoe 100, or be omitted for production cost reduction or weight lightening if necessary.

The sensing unit 140 is typically implemented using one or more sensors configured to sense internal information of the smart shoe, the surrounding environment of the smart shoe, user information, and the like. The sensing unit 140 may include at least one of a proximity sensor 341, an illumination sensor 142, a touch sensor, an acceleration sensor 144, a magnetic sensor, a G-sensor, a gyroscope sensor 145, a motion sensor 143, an RGB sensor, an infrared (IR) sensor, a finger scan sensor, a ultrasonic sensor, an optical sensor, a battery gauge, an environment sensor (for example, a barometer, a hygrometer, a thermometer, a radiation detection sensor, a thermal sensor, and a gas sensor, among others), and a chemical sensor (for example, an electronic nose, a health care sensor, a biometric sensor, and the like), to name a few. The mobile terminal 100 may be configured to utilize information obtained from sensing unit 140, and in particular, information obtained from one or more sensors of the sensing unit 140, and combinations thereof.

Particularly, the acceleration sensor 144 and the gyro sensor 145 mentioned in the present invention can be conceptually included in the motion sensor 143.

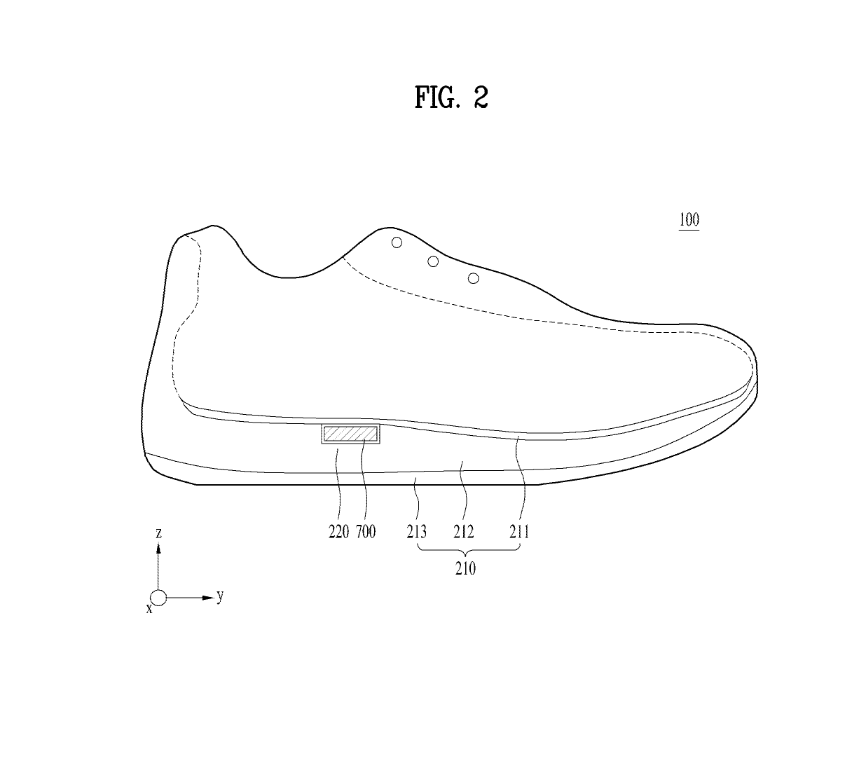

Moreover, the pressure sensor 146 may mean a pressure switch module 200 (cf. FIG. 2) that will be described later. The pressure sensor 146 may be conceptually included in the motion sensor 143. For clarity of the following description, the motion sensor 143 and the pressure sensor 146 shall be described separately.

The output unit 150 is typically configured to output various types of information, such as audio, video, tactile output, and the like. The output unit 150 is shown having a display unit 151, an audio output module 152, a haptic module 153, and an optical output module 154.

The interface unit 160 serves as an interface with various types of external devices that can be coupled to the smart shoe 100. The interface unit 160, for example, may include any of wired or wireless ports, external power supply ports, wired or wireless data ports, memory card ports, ports for connecting a device having an identification module, audio input/output (I/O) ports, video I/O ports, earphone ports, and the like. In some cases, the smart shoe 100 may perform assorted control functions associated with a connected external device, in response to the external device being connected to the interface unit 160.

The memory 170 is typically implemented to store data to support various functions or features of the smart shoe 100. For instance, the memory 170 may be configured to store data or instructions for operations of the smart shoe 100, and the like.

The controller 180 controls overall operations of the smart shoe 100 in general as well as an operation related to the application program. The controller 180 processes signals, data, information and the like inputted or outputted through the aforementioned components or uses data or commands stored in the memory 170, thereby providing or processing information or functions appropriate for a user using the data or commands stored in the memory 170.

The power supply unit 190 can be configured to receive external power or provide internal power in order to supply appropriate power required for operating elements and components included in the smart shoe 100. The power supply unit 190 may include a battery, and the battery may be configured to be embedded in the terminal body, or configured to be detachable from the terminal body.

At least some of the above components can cooperatively operate to implement operations, controls and controlling methods of the smart shoe 100 according to various embodiments described in the following. The operations, controls or controlling methods of the smart shoe 100 can be implemented on the smart show 100 by running at least one application program saved to the memory 170.

FIG. 2 is a cross-sectional diagram of a y-z plane of a smart shoe 100 related to the present invention.

A sole frame 210 means a direct/indirect region touched by a wearer's sole. Namely, in the smart shoe 100, the sole frame 210 may mean a frame of a region provided between a wearer's foot and a bottom. The sole frame 210 may include an insole 211 directly touched by the wearer's sole, an outsole 213 provided to a bottom end of the smart shoe 100 so as to directly touch an external environment, i.e., a ground surface, and a midsole 212 provided between the insole 211 and the outsole 213 so as to form a predetermined volume.

The insole 211 may be a shoe insert that is a frequently used word. If necessary, the insole 211 and midsole 12 may be configured integrally instead of being separated. The insole 211 may include a separate member or may be provided as a bonded configuration using an adhesive agent or the like.

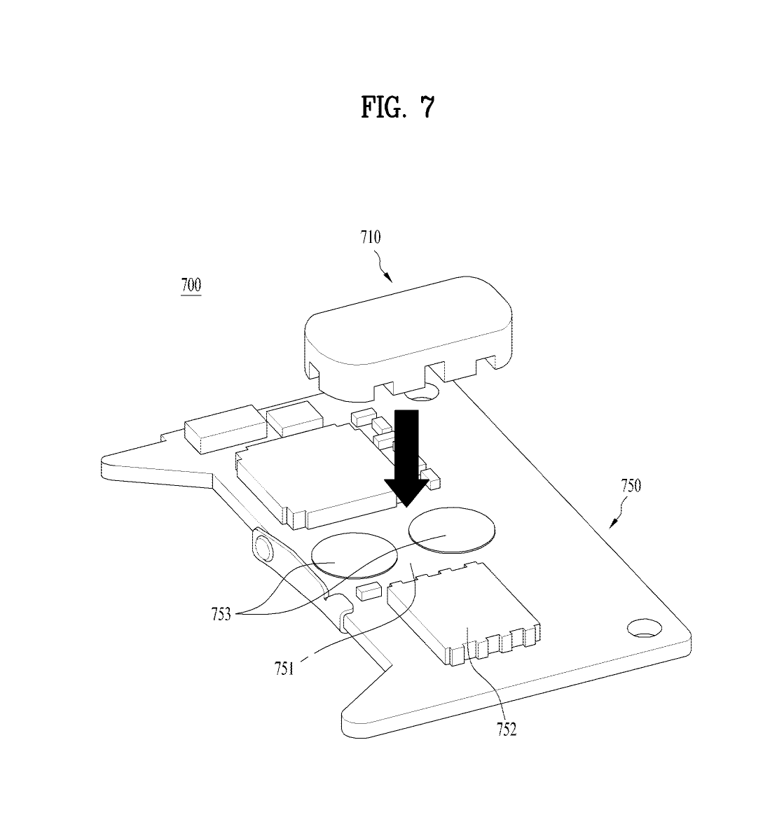

A pressure switch module 700 including a pressure switch 710 (cf. FIG. 7) to be described later can be provided to the sole frame 210. When the pressure switch module 200 touches a floor as a wearer walks or runs, as a predetermined pressure is applied, the pressure switch module 200 provided to the sole frame 210 can generate a signal or data indicating a presence or non-presence of pressurization.

So to speak, the wearer's walking or running activates the pressure switch module 700 so as to attempt a electrical contact of a first circuit unit 751 (cf. FIG. 7).

By the electrical contact, the first circuit unit 751 can generate an electric signal (e.g., current).

The controller recognizes a presence or non-presence of a current or signal generated from the first circuit unit 751 as an ON/OFF binary signal and is able to control various subsequent operations based on the ON/OFF signal.

The first circuit unit 751 generates a current or signal and the controller 180 (cf. FIG. 1) recognizes the ON/OFF current or signal generated from the first circuit unit 751. Thus, the first circuit unit 751 and the controller 180 may perform separate and independent processes, respectively. In some cases, such processes may mean a series of operations performed by a single circuit.

Namely, as the first circuit unit 751 connecting the controller 180 is electrically connected by the pressure switch 710, i.e., current is generated, if electricity is applied to the controller 180, it can be recognized as an ON signal.

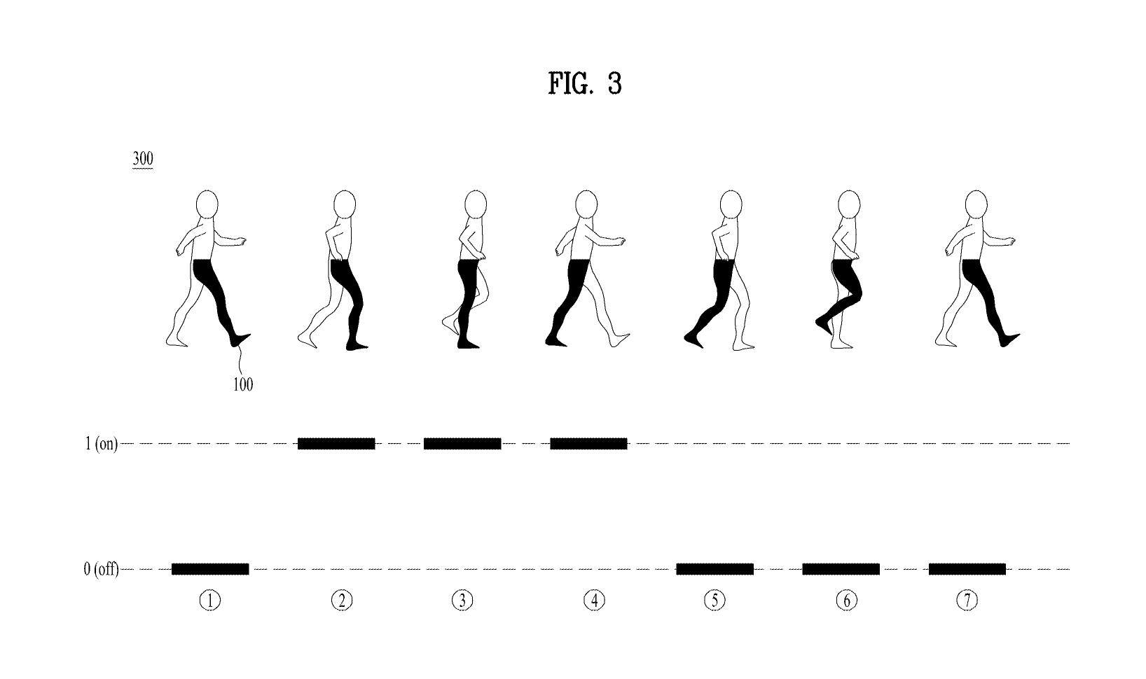

FIG. 3 is a time-series diagram of correspondence to a motion, i.e., a step of a wearer 300 of a smart shoe related to the present invention.

When a wearer 300 wears a smart shoe 100 and steps on a floor, an ON signal by the first circuit unit 751 may be generated. When the wearer 300 wears the smart shoe 100 and lifts the smart shoe 100 from the floor, an OFF signal by the first circuit unit 751 may be generated.

As a pressure value over a specific value is applied to the states \textcircled{2} to \textcircled{4} of FIG. 3, a value ‘1’, i.e., an ON signal is generated from the first circuit unit 751. As a pressure value below the specific value is applied to the rest of cases \textcircled{1} and \textcircled{5}-\textcircled{7} [symbol] , a value ‘0’, i.e., an OFF signal may be generated from the first circuit unit 751.

Yet, such results may vary sufficiently depending on how to adjust a rigidity or interval of the pressure switch 710 by setting signal generation, i.e., a threshold pressure value, which enables the first circuit unit 751 to be connected, to a prescribed value.

For example, if the threshold pressure value is increased more, a pressure threshold for enabling an ON signal to be generated is raised higher. Hence, only in case of \textcircled{2} or \textcircled{3}, a value ‘1’, i.e., an ON signal is generated from the first circuit unit 751. In the rest of cases \textcircled{1} and [symbol] \textcircled{5}˜\textcircled{7}, a value ‘0’, i.e., an OFF signal may be generated from the first circuit unit 751.

Therefore, through the above results, it is able to determine a start and end of one step of a wearer. If steps are repeated, it is able to obtain a period of each step.

In case of taking FIG. 3 as an example, \textcircled{2} is interpreted as a start of a step and a point that becomes \textcircled{1} through \textcircled{7} can be interpreted as an end of one step.

Moreover, if such a change from \textcircled{2} to \textcircled{1} is repeated, it is able to interpret a plurality of steps by obtaining one period as one step.

Namely, in order to interpret a unit of a step according to a related art, in case of interpreting a point at which a speed value of a smart shoe 100 through a motion sensor is 0 (zero), error may be generated as several variables work (i.e., noise works). Yet by removing such noise through ON/OF signal of the pressure switch 710, it is able to distinguish an accurate step unit.

The pressure switch 710 may operate depending on whether a pressure works in a direction toward the sole frame 210 from a sole, i.e., a bottom end direction. Yet, the bottom end direction is not always required. If necessary, the pressure switch 710 may operate with reference to a pressure in a direction deviating at a predetermined angle from the bottom end direction. In case that a plurality of the pressure switches 710 are provided, they may operate in several directions.

Such a pressure direction may be based on a wearer's normal step and acting force, or vary based on an individually different step and acting force of a wearer.

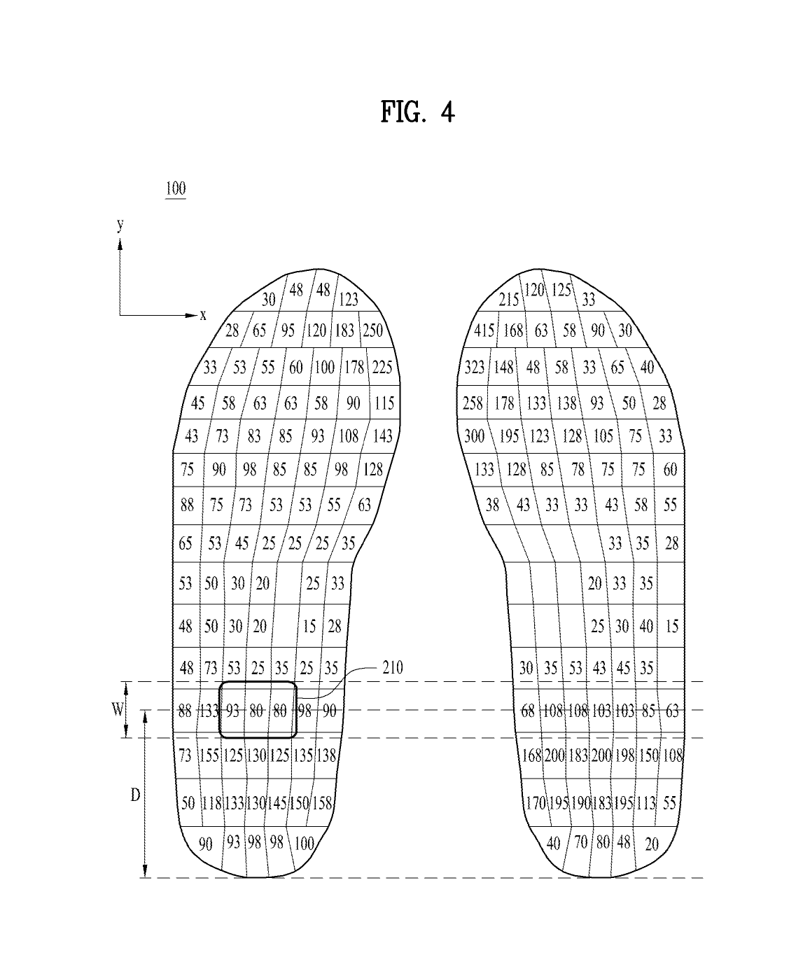

FIG. 4 is a diagram showing distribution of pressure working on a smart shoe 100 related to the present invention.

FIG. 4 shows pressure distribution in x-y plane, working when a smart shoe 100 targeting a smart shoe wearer steps on a floor.

Although there may be errors, it can be observed that high pressure works on a front part of a foot, and more particularly, on a region around a big toe and a heel region of the foot.

Relatively, it can be observed that pressure in relatively small size equal to or smaller than 100 kpa works on a center part of the foot.

Such a pressure result may be the basis for determination of a location at which the pressure switch 710 will be installed. In case that the pressure switch 710 is provided to the heel region having relatively high pressure applied thereto, it may cause a problem to durability of a device. And, it may cause disadvantage to wearer's wearing feeling due to a switch case including the pressure switch 710, which will be described later.

On the contrary, if the pressure switch 710 is provided by inclining toward a foot center region receiving relatively low pressure, a size of pressure working on the pressure switch 710 is too small. And, it may misjudge whether pressure works according to factors such as a wearer's foot shape, a step property and the like.

Therefore, the pressure switch 710 can be provided to a region W between the foot heel of the region near 100 kpa and the foot center. If necessary, the pressure switch 710 may be provided to a region on which pressure over 100 kpa works.

Although it may vary depending on a size of the smart shoe 100, for a component of direction of y-axis (i.e., vertical axis) of the smart shoe 100, the pressure switch 710 is preferably provided to a location spaced apart in a distance D (e.g., about 50 mm) from a rear end of the sole frame 210 to the pressure switch 710. The location can be confirmed flexibly with a margin of about top/bottom 20 mm if necessary for size, shape and the like of the smart shoe 100.

In determining a unit of step, if the pressure working time gets shorter, the end and start point of one step can be determined more accurately. Namely, it is advantageous that a length of a zero-velocity interval is minimized. As a result of measurement, a region having a relatively short zero-velocity region becomes the region W on which 100 kpa works.

The aforementioned numerical values are exemplary all, by which the present invention is non-limited. This applies to other numerical values mentioned in the present specification.

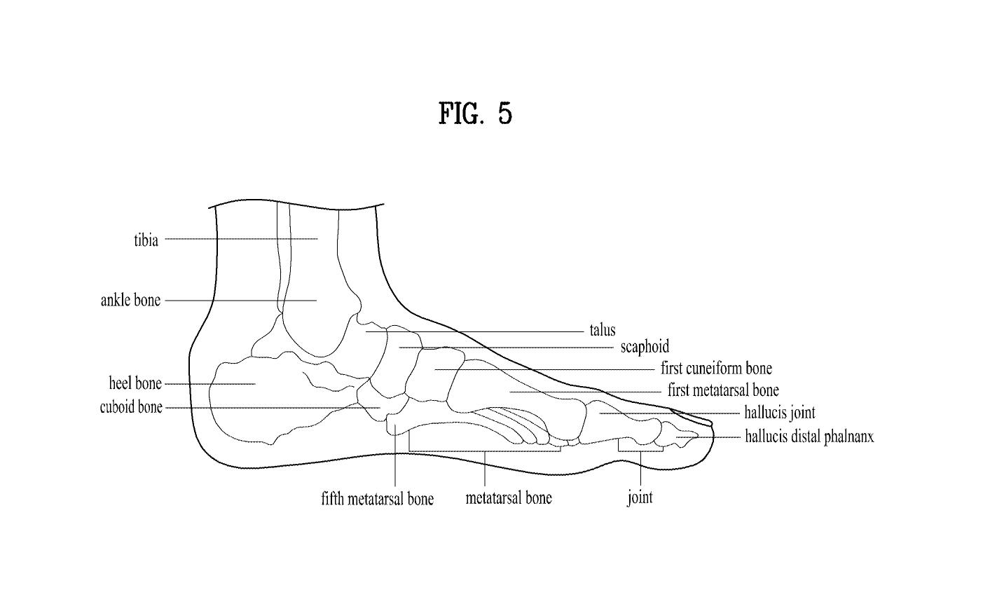

FIG. 5 is a schematic diagram of an internal structure of human foot bones.

The region W may correspond to a region near heel bone, cuboid bone or fifth metatarsal bones with reference to wearer's foot bones.

Referring to FIG. 4 again, for a direction component of x-axis that is a horizontal axis of the smart shoe 100, the pressure switch 710 can be provided near a center of both ends. If the pressure switch 710 is provided near the center of both ends, it is able to minimize foreign body sensation felt by a wearer and the possibility of damage caused to the pressure switch 710 by an external force.

A threshold pressure value may be differently applicable according to physical and habitual factors such as wearer's height, weight, foot size and the like. Yet, since a presence or non-presence of ON/OFF of the pressure switch 710 depends on material and structure, the material and structure determined pressure switch 710 has a determined threshold pressure value.

The motion sensor 143 (cf. FIG. 1) installed in the smart shoe 100 may mean a configuration for directly sensing a motion of the smart shoe 100. The motion sensor 143 may include the acceleration sensor 144 (cf. FIG. 1) and the gyro sensor 145 (cf. FIG. 1). If necessary, one of the acceleration sensor 144 and the gyro sensor 145 may be provided.

Through the motion sensor 143, it is able to sense a motion such as a location change for a location and time in 2- or 3-dimension of the smart shoe 100.

The motion sensor 143 can perform sensing by being supplied with current through a second circuit unit configuring a circuit independent from the first circuit unit 751.

The controller 180 can control current supply to the second circuit unit. The controller 180 can include a micro controller unit (MCU) 752 (cf. FIG. 7) such as a central processing unit (CPU).

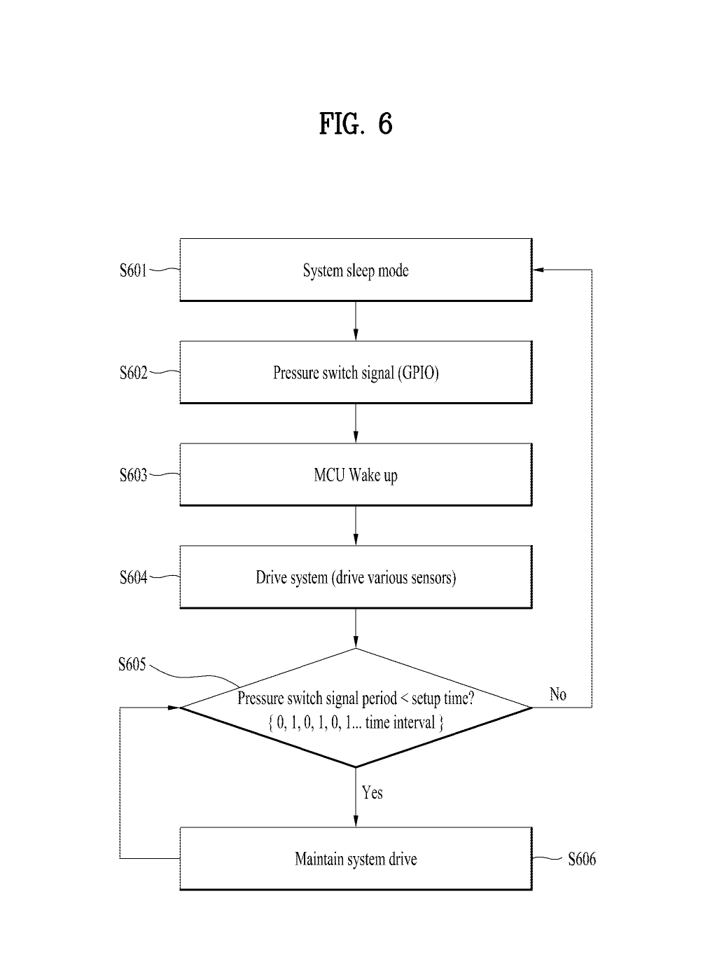

FIG. 6 is a flowchart for a smart shoe 100 related to the present invention. For clarity, FIG. 1 and FIG. 7 are referred to as well.

Based on a presence or non-presence of generation of a current or signal of the first circuit unit 751, it is able to control current supply or cutoff for the second circuit unit, i.e., the motion sensor 143.

If current fails to flow in the first circuit unit 751 for a preset time or an electrical signal period generated from the first circuit unit 751 deviates from a preset pattern, it can be interpreted as a state that a wearer does not wear the smart shoe 100 or a state that the wearer does not move despite wearing the smart shoe 100.

Hence, the controller 180 can execute a system sleep mode to minimize power consumption of the smart shoe 100 by deactivating the second circuit unit controlling the motion sensor 143 [S601].

If a current or electric signal is generated from the first circuit unit 751 through the pressure switch 710 in the system sleep mode, it can be interpreted as a wearer is active by wearing the smart shoe 100 [S602].

Hence, the current of the first circuit unit 751 generated in the system sleep mode can activate the controller 180 including the MCU 752 [S603]. Here, if the MCU 752 is already in activated state, the present step may be skipped.

The activated controller 180 can release the system sleep mode of the smart shoe 100 and drive the system. The drive of the system may mean to drive various electric components and sensors provided to the smart shoe 100. Particularly, by activating the second circuit unit controlling the motion sensor 143, it is able to control a motion of the smart shoe 100 to be sensed.

The controller 180 receives a signal of ON/OFF current through the first circuit unit 751 by real time and then compares a signal generation period of the first circuit unit 751, which is generated by the pressure switch 710, with a preset time or pattern [S605].

If the current flows in the first circuit unit 751 within a preset time, i.e., if a value of ‘1’ that is an ON value is received within a predetermined time, the drive of the system of the smart shoe 100 can be maintained. Particularly, the activation of the second circuit unit controlling the motion sensor 143 can be maintained continuously [S606].

On the contrary, if the current does not flow in the first circuit unit 751 for the preset time, i.e., if a value of ‘0’ that is an OFF value continues over the predetermined time, the controller 180 can deactivate the while system of the smart shoe 100, i.e., control it to enter a system sleep mode. Particularly, the controller 180 can perform the power supply or cutoff on the second circuit unit.

FIG. 7 is a diagram of a pressure switch 710 and a first circuit unit 751 related to the present invention.

The pressure switch 710 can operate by being linked to the first circuit unit 751. The first circuit unit 751 can be installed in the main board 750. For clarity, FIG. 7 schematically shows a state before joining the pressure switch 710 and the first circuit unit 751 together. Here, the pressure switch 710 can be fixed to the main board 750 by a separate member.

If a pressure below a specific value works on the pressure switch 710, the pressure switch 710 electrically separates the first circuit unit 751.

Until the first circuit 751 is connected by a conductive member of the pressure switch 710, the first circuit unit 751 can maintain an open circuit, i.e., an electrically open state. The first circuit unit 751 in the open state can be implemented by two contact terminals 753 spaced apart from each other.

If a pressure over the specific value works on the pressure switch 710, the pressure switch 710 can be electrically to the contact terminal 753 of the first circuit unit 751. The spaced two contact terminals 753 are electrically closed by the conductive member of the pressure switch 710, whereby the first circuit unit 751 can form a closed circuit. If the first circuit unit 751 forms the closed circuit, a current or signal can be generated.

By the electrical contact, the first circuit unit 751 can generate a current or signal.

The controller 180 recognizes a presence of non-presence of the current or signal generated from the first circuit unit 751 as an ON/OFF binary signal and is then able to control various subsequent operations based on the ON/OFF signal.

According to the generation of the current or signal of the first circuit unit 751, the controller 180 recognizes the ON/OFF signal, which may be interpreted as a separate independent process. Yet, this may mean a single operation performed in the same single circuit. Namely, the current generated from the first circuit unit 751 directly connects the controller 180 electrically, thereby being recognized as an ON signal by itself.

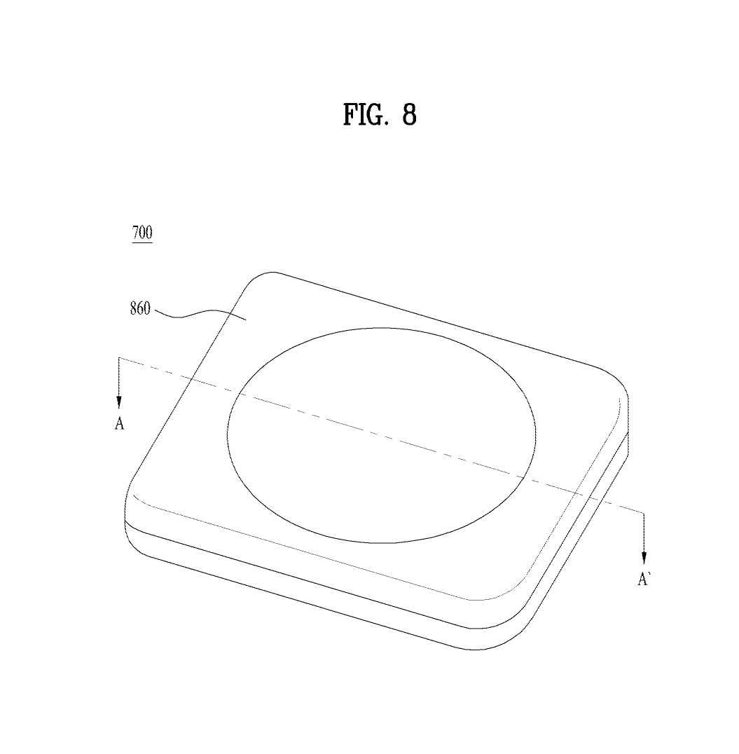

FIG. 8 is a front perspective diagram of a pressure switch module 700 related to the present invention.

The pressure switch 710, the main board 750 and the like described in FIG. 7 can be implemented as a single pressure switch module 700. Such a pressure switch module 700 may be installed in a switch housing 860. This shall be described in detail later.

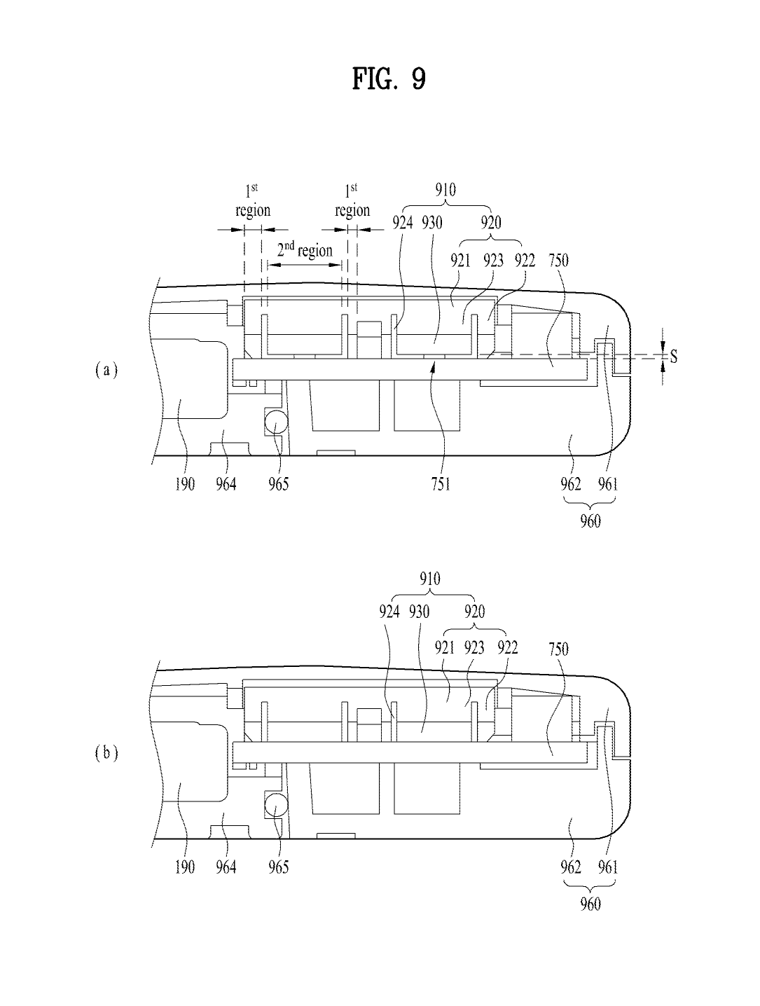

FIG. 9A and FIG. 9B are cross-sectional diagrams along an A-A′ direction of FIG. 8.

Particularly, FIG. 9A is a cross-sectional diagram before a pressure switch 710 according to one embodiment of the present invention is moved by pressure, and FIG. 9B is a cross-sectional diagram of a state that the pressure switch 710 according to one embodiment of the present invention is moved by pressure.

The main board 750 is provided to a bottom end of the pressure switch 710 so as to install the first circuit unit 751 therein. The second circuit unit and the controller 180 can be installed in the main board 750. Or, at least one of the second circuit unit and the controller 180 may be provided to an independently spaced separate main board 750 if necessary.

The first circuit unit 751 may be provided as at least one of types such as a combination of film & metal electrode, film & conductive polymer, film & CNT, and film & graphene. Or, the first circuit unit 751 may be provided as a type of injection molded plastic & MID (mold interconnect devices).

A conductive member 930 of the pressure switch 710 can connect the first circuit unit 751 electrically when coming into contact with the first circuit unit 751. The conductive member 930 may include conductive material such as conductive silicon, metal gasket, metal board, metal deposition, conductive polymer, CNT, graphene, etc. And, the conductive member 930 may be configured with a combination of injection molded plastic & MID (mold interconnect devices).

When a pressure below a specific value is applied, a fixing member 920 of the pressure switch 710 spaces the conductive member 930 apart from the first circuit unit 751. When a pressure over the specific value is applied, the fixing member 920 can enable the conductive member 930 to come in contact with the first circuit unit 751.

The fixing member 920 may include a non-conductive fixing portion 922 mounted on the main board 750, i.e., the first circuit unit 751. The non-conductive fixing portion 922 contains non-conductive material, thereby not affecting current flow of the first circuit unit 751 despite being directly fixed to the first circuit unit 751 or the main board 750.

A displacement portion 923 of the fixing member 920 may be provided in a manner of being connected to the non-conductive fixing portion 922 through a top end portion 921 of the fixing member 920. The displacement portion 923 of the fixing member 920 directly fixes the conductive member 930 and is displaced by a pressure value over a specific value, thereby connecting the conductive member 930 to the first circuit unit 751.

In order for the displacement portion 923 to be displaced by the pressure value over the specific value, at least one region of the top end portion 921 may be provide with elastic material. The conductive member 930 displaces the fixed displacement portion 923 downward owing to the elasticity of the at least one region of the top end portion 921, whereby the displacement portion 923 may come in contact with the first circuit unit 751.

The displacement portion 923 of the fixing member 920 and the conductive member 930 may be formed by being combined together through double injection.

The fixing member 920 may include silicon rubber or injection molded plastic such as polycarbonate, polyamide and the like. The fixing member 920 may include substance such as metal board or metal die casting.

The non-conductive fixing portion 922 and the displacement portion 923 may diverge to the bottom end from the first region of the top end portion 921 and the second region of the top end portion 921, respectively. The top end portion 921, the non-conductive fixing portion 922 and the displacement portion 923 may be formed integrally, or by a process such as double injection or the like using different separate materials if necessary.

The second region may be located between the first regions. If necessary, the second region or the first region may include a plurality of regions of the top end portion 921.

The first region may include three regions including both end regions and a center region of the top end portion 921 of the pressure switch 710, and the second region may include a region between the first regions of the three regions. If the first region becomes both of the end regions and the center region, the non-conductive fixing portion 922 of the pressure switch 710 can be stably joined to the main board 750 or the first circuit unit 751 and is able to prevent the conductive member 930 provided to the second region from being unintentionally connected to the first circuit unit 751.

The non-conductive fixing portion 922 and the displacement portion 923 may form a slit 924 spaced by a predetermined gap.

At least one region including the elastic material of the top end portion 921 may mean a region corresponding to the slit 924. Since the non-conductive fixing portion 922 is fixed and the displacement portion 923 is displaced, using the slit 924 as a boundary, if a nearby region particularly includes elastic material, displacement can occur well.

The pressure switch 710 can be installed in a switch housing 960.

The switch housing 960 can fix the pressure switch 710 thereto by joining a top case 961 and a bottom case 962 together.

The top case 961 may have a shape of a thin plane to transfer pressure to the pressure switch 710 from a sole of a wearer well and be provided in a manner of being directly in contact with the pressure switch 710. As the top case 961 contains elastic material, it can transfer a force to the pressure switch 710 well. For example, the top case 961 may be formed of silicon.

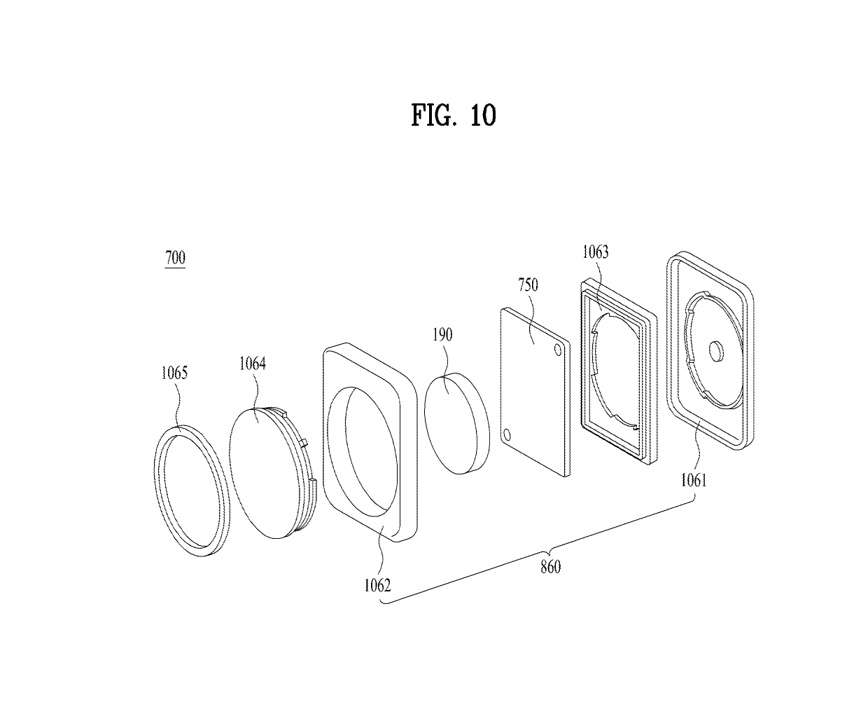

FIG. 10 is a diagram showing one embodiment of a pressure switch module 700 related to the present invention.

The pressure switch module 700 may mean a structural unit for installing the components (e.g., the pressure switch 710, the main board 750, etc.) capable of performing a function of a pressure sensor, and physically include the entire configuration installed in a switch housing 860.

The components such as the pressure switch 710, the main board 750 and the like can be installed in the switch housing 860. And, the switch housing 860 can be configured with an assembly of a top case 1061 and a bottom case 1062 provided to a front side of the switch housing 860.

In order to raise the assembly reliability of the main board 750 and the top case 1061, a front case 1063 may be subsidiarily joined between the two configurations.

The power supply unit 190 can be installed in the switch housing 860 of the pressure switch module as well. The power supply unit 190 may play a role in supplying power to the controller 180 and the like.

For the smooth replacement of the power supply unit 190, a battery cover 1064 joined to the bottom case 1062 may be included.

A gap between the battery cover 1064 and the bottom case 1062 is blocked by a waterproof ring 1065 so as to prevent a waterproof problem.

The second circuit unit may be installed in the switch housing 860 if necessary.

Referring to FIG. 2 again, with reference to the ※y plane, the switch housing 860 including the pressure switch 710 may be provided to a pressure region in the sole frame 210 corresponding to at least one of a heel bone, a cuboid bone and a fifth metatarsal bones in the wearer's sole bone. Hence, the switch housing 860 having the pressure switch 710 installed therein can be provided to the pressure region of the sole frame 210 as well.

The sole frame 210 may include a seat portion 220 forming a step difference in a region in which the switch housing 860 will be installed. The seat portion 220 having the switch housing 860 installed therein may be particularly formed to a region of the midsole 212 of the sole frame 210.

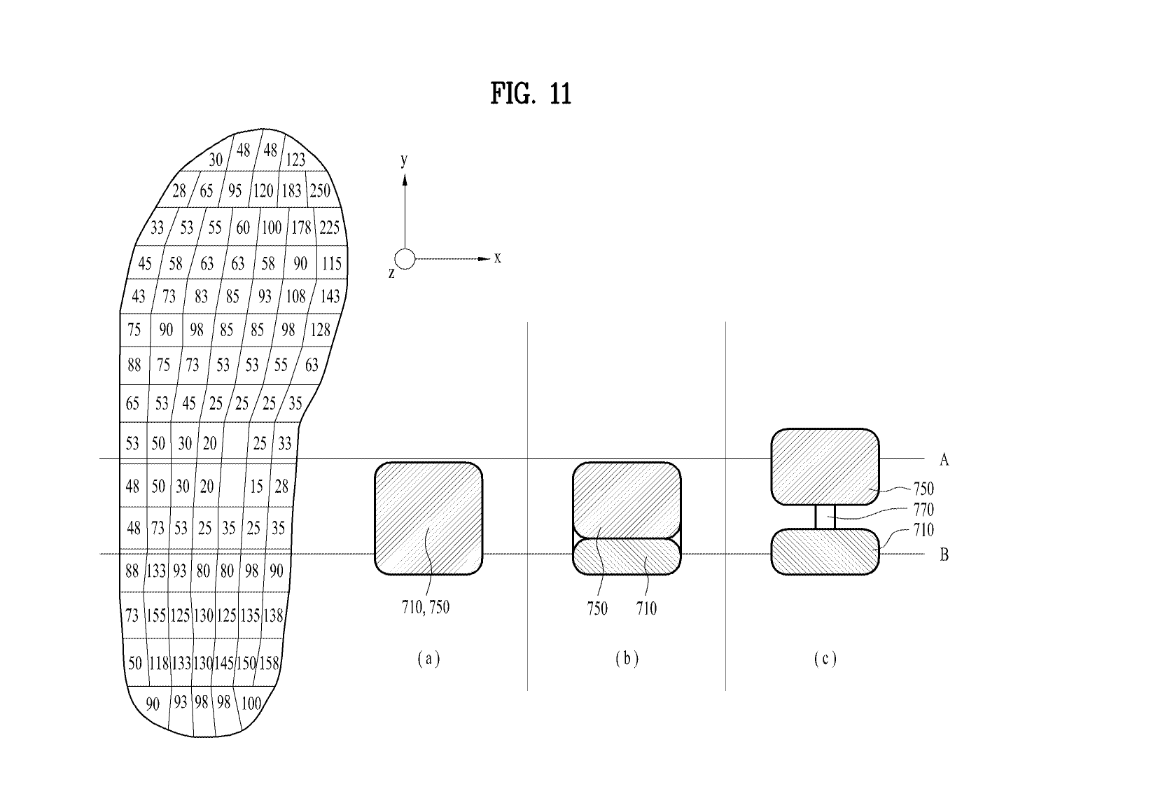

FIG. 11 is a diagram showing several embodiments of a smart shoe 100 related to the present invention.

As described above, referring to FIG. 11(a), the pressure switch 710 and the main board 750 provided with the first circuit unit 751 can be provided by being stacked in z-axis direction. If the pressure switch 710 and the main board 750 are provided by being stacked, since a separate circuit line 770 for connecting the two components externally is not necessary, product costs can be reduced and problems due to short circuit can be minimized.

Moreover, as the pressure switch 710 and the main board 750 can be installed in the switch housing 860 by occupying a small volume, an overall volume can be minimized and a region of the seat portion 220 (cf. FIG. 2), in which the switch housing 860 will be installed, can be minimized as well.

FIG. 11(b) shows a method of preventing the main board 750 and the pressure switch 710 from overlaying each other in a z-axis direction. Since a relatively high pressure works on a line B rather than a line A, the main board 750 can be provided horizontally in x-y plane without overlaying the pressure switch 710 in the z-axis direction.

FIG. 11(c) shows that the main board 750 and the pressure switch 710 are connected electrically through a separate connecting line 770. As the main board 750 is completely located on the line A in comparison with the embodiments of FIG. 11(a) and FIG. 11(b), it is able to minimize weight working from a wearer's foot. Hence, reliability of durability of the main board 750 can be raised.

So far, the smart shoe system according to the present invention is described with reference to FIGS. 1 to 11. Such a smart shoe system can operate based on smart shoe tracking algorithm on the basis of sensing data of the pressure senor using PDR algorithm.

The smart shoe system operating based on the smart shoe tracking algorithm is described in detail as follows.

The smart shoe tracking algorithm according to the present invention can accurately sense a motion (e.g., a step) of a smart shoe wearer based on sensing data of the pressure sensor using PDR algorithm. And, the smart shoe tracking algorithm can calculate a step path, a step direction, a stride, a height and the like of a smart shoe wearer easily and accurately. And, the smart shoe tracking algorithm interworks with the pressure switch or the pressure sensor circuit or module, thereby contributing to power consumption minimization and efficiency maximization of the smart shoe system.

A smart shoe according to the present invention can track, sense and record motion data such as a moving time, velocity, distance or position, orientation, trace or path, attitude, stride and the like in a state that a wearer wears the smart hoe. In doing so, basically, according to the present invention, tracking, sensing and the like are accurately performed without missing a step of the smart shoe wearer. Through this, sensing of the aforementioned various motion data is possible. The motion data may include sensing data for a step of a smart shoe wearer as well.

As described above, a motion sensor in the present specification may mean a pressure sensor only, or mean a pressure sensor, acceleration sensor, a gyro sensor and the like. Here, the acceleration sensor and the gyro sensor may be named a PDR sensor or an inertia sensor. As described above, when motion data of a wearer is measured through the PDR sensor, the PDR sensor should maintain an always-measurable state, i.e., a power consumed state. Hence, it may be difficult to reduce power consumption and lighten weight of a smart shoe. When a motion trace or path of the smart shoe is obtained through the PDR sensor, it may be difficult to accurately distinguish a wearer's step due to noise generated from the inertia sensor, whereby cumulative error may be generated. To resolve it, the present invention further employs the pressure switch or sensor in addition to the PDR sensor. For this, the foregoing description will be cited and redundant description shall be omitted.

In summary, the present invention can obtain various and accurate motion data for a smart shoe according to a smart shoe tracking algorithm based on sensing data of a pressure sensor in comparison with the related art.

Motion data sensing, correction and acquisition of motion data sensed through a smart shoe tracking algorithm, and smart shoe system therefor according to the present invention are described in detail as follows.

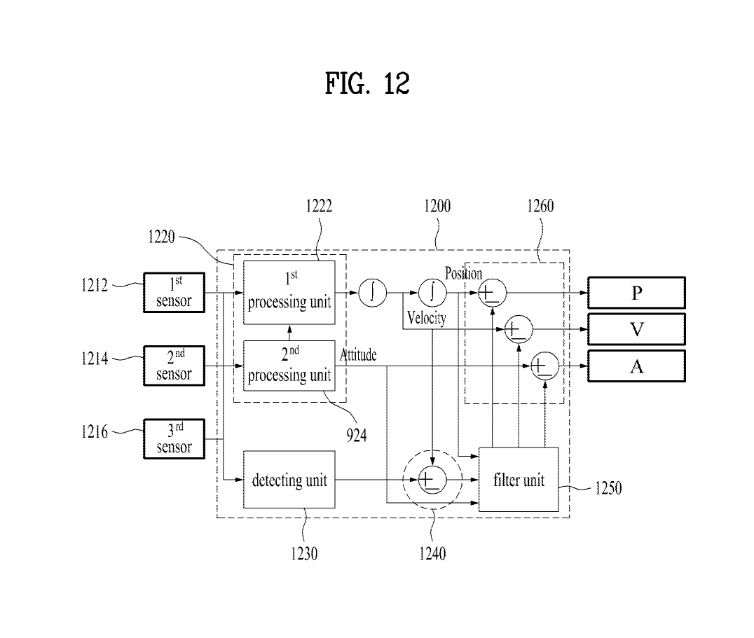

FIG. 12 is a diagram showing a configuration for smart shoe tracking algorithm according to one embodiment of the present invention.

In the following, components for a smart shoe tracking algorithm shown in FIG. 12 are described by being named a smart shoe tracking data processing unit 1200 or a tracking data processing unit 1200 (hereinafter named a tracking data processing unit). As described above, it may be named a data processing unit. The tracking data processing unit 1200 can be implemented as hardware such as circuit or module, or software embedded in one configuration of the aforementioned smart shoe system. Yet, it is not necessary for the tracking data processing unit 1200 to be one configuration of the smart shoe. And, the tracking data processing unit 1200 may be designed as one configuration of another device capable of receiving and processing sensing data of sensors of the smart shoe.

The tracking data processing unit 1200 can cumulatively calculate a moving distance (position (3D)) by estimating a moving velocity (velocity (3D)) and a moving direction (attitude (3D)) of a wearer of the smart shoe through a sensor module mounted on the smart shoe.

Operations of the tracking data processing unit 1200 according to the present invention are described with reference to FIG. 12 as follows.

A tracking data processing unit 1200 processes tracking data for a wearer of a smart shoe based on sensing data of a sensor module (or sensor unit) mounted on the smart shoe using a processing unit 1220 and a filter unit 1250. This is related to PDR algorithm related to a related art inertia navigation system. The PDR algorithm can refer to the well-known contents, and its details shall be omitted.

A tracking data processing process through the processing unit 1220 and the filter unit 1250 is described as follows.

First of all, the processing unit 1220 includes a first processing unit 1222 and a second processing unit 1224.

The first processing unit 1222 receives data sensed by a first sensor 1212, processes the received sensing data, and then outputs the processed data to a first integrator. Herein, the first sensor 1212 includes an acceleration sensor for example. Particularly, the first processing unit 1222 subtracts gravity from the data sensed from the first sensor 1212.

The second processing unit 1224 receives data sensed by a second sensor 1214 and processes the received sensing data. The processed data is outputted to the first processing unit 1222 and a mixer. Here, the second sensor 1214 includes a gyro sensor for example. The moving direction data may include yaw data, pitch data, roll data, etc. The second processing unit 1224 calculates a moving direction A of an insole of the smart shoe based on the data sensed from the second sensor 1214.

In the above description, output data of the first integrator may include a moving velocity data V in itself and data processed by the second processing unit 1224 may include moving direction data A of the smart shoe wearer in itself.

In the above description, data remaining after excluding moving velocity data v1 from output data of the first integrator, i.e., moving distance data p0 is cumulated by being inputted to a second integrator. The moving velocity data v1, the output data of the second integrator (i.e., moving distance data p1), and moving direction data a1 of the second processing unit 1224 are inputted to the filter unit 1250. The filter unit 1250 filters the inputted moving velocity data v1, moving distance data p1 and moving direction data a1 using Kalman filter mainly used by the PDR algorithm. The inputted moving velocity data v1, moving distance data p1 and moving direction data a1 are filtered by the filter unit 1250 so as to be outputted as moving velocity data v2, moving distance data p2 and moving direction data a2. The outputted moving velocity data v2, moving distance data p2 and moving direction data a2 are outputted to a mixer unit 1260.

The mixer unit 1260 includes a first mixer for a moving distance, a second mixer for a moving velocity, and a third mixer for a moving direction.

The first mixer calculates a final moving distance data P by mixing a moving distance data p1, which is an output of the second integrator, and a moving distance data p2, which is an output of the filter unit 1250, together.

The second mixer calculates a final moving velocity data V by mixing a moving velocity data v1 extracted from the first integrator and a moving velocity data v2 that is an output of the filter unit 1250 together.

The third mixer calculates a final moving direction data A by mixing a moving direction data a1, which is an output of the second processing unit 1224, and a moving direction data a2, which is an output of the filter unit 1250, together.

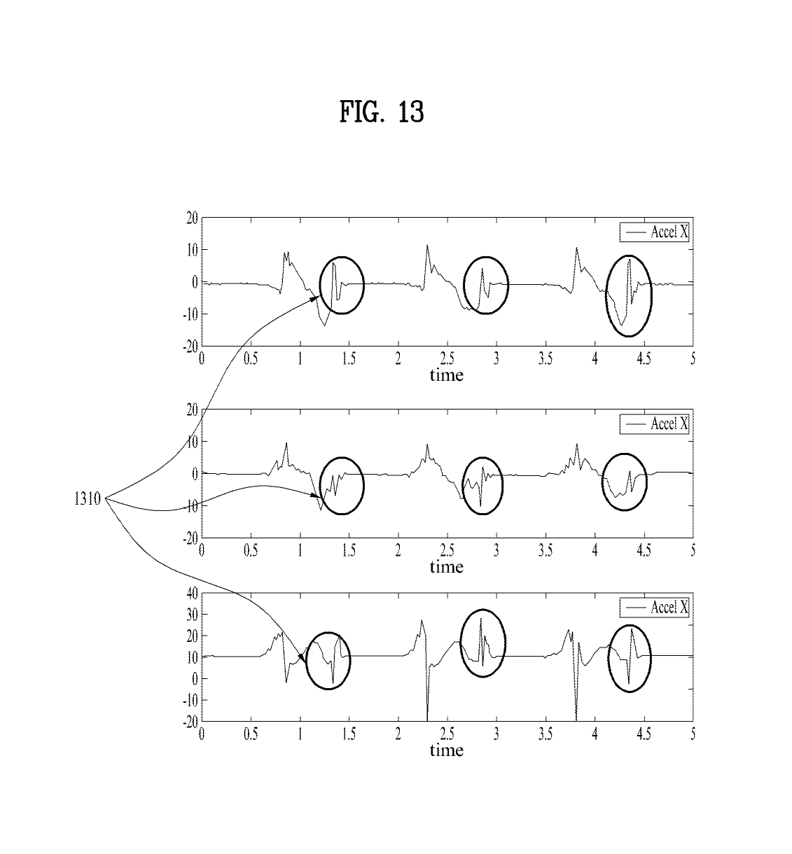

If the tracking data processing unit 1200 processes the tracking data for the smart shoe wearer based on sensing data of the sensor module mounted on the smart shoe using the processing unit 1220 and the filter unit 1250 shown in FIG. 12, it is able to obtain a graph shown in FIG. 13.

Yet, referring to FIG. 13, if the processing is performed based on data sensed by the first sensor 1212 and the second sensor 1224, since there exists a noise region 1300, as shown in the drawing, it may fail to accurately detect a step of the smart shoe wearer. Namely, as zero velocity is not accurately measured due to the noise effect, it is unclear to distinguish a previous step and a next step. Hence, it may not be able to detect a step. This may not be a big problem in a state that the smart shoe wearer walks only or is in a static state. Yet, if a moving velocity rises or a stride is narrow, it may affect the whole data to cause error. The noise may be generated from every step, thereby causing considerable error to the whole data possibly. Therefore, if the noise region is minimized or removed, tracking data can be calculated more accurately.

In order to minimize or remove errors due to the noise, the present invention further refers to the sensing data of the pressure sensor mentioned in the foregoing description.

Referring to FIG. 12, the tracking data processing unit 1200 further includes a detecting unit 1230 and a fourth mixer 1240.

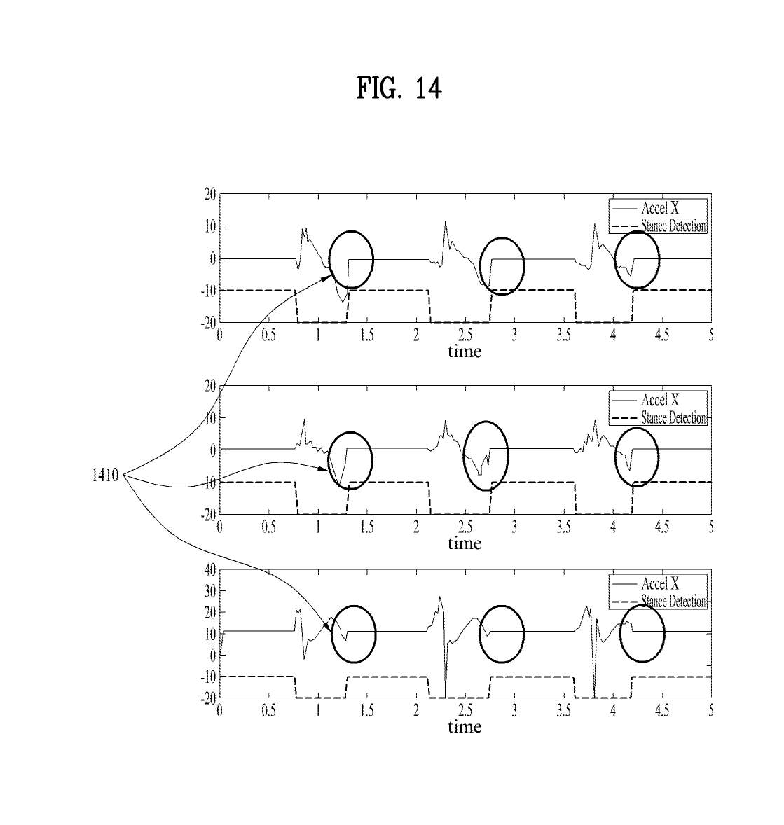

The detecting unit 1230 receives data sensed from a third sensor 1216, processes the received data, and outputs the processed data to the fourth mixer 1240. Here, the third sensor 1216 may include the pressure sensor of the present invention. Hence, the aforementioned contents are cited for the pressure sensor. Data sensed by the pressure sensor may be generated from every step of a smart shoe wearer for example. This may correspond to a graph 1410 in the bottom part of FIG. 14 for example.

The detecting unit 1230 detects zero velocity from the data sensed and inputted from the third sensor 1216. This can be easily detected from the graph data (in FIG. 14) sensed as the third sensor 1216 operates as a pressure switch according to a wearer's step.

A zero velocity data z1 detected by the detecting unit 1230 is mixed with a moving velocity data v1 extracted from the first integrator in the fourth mixer 1240, and the mixed data becomes an input v1′ different from the former input v1 of the filter unit 1250. Thereafter, as described above, data of a moving distance P, a moving velocity V and a moving direction A are calculated after filtering in the filter unit 1250.

This is described with reference to FIG. 13 and FIG. 14 as follows. In FIG. 13, as described above, a noise region 1310 exists. Yet, referring to FIG. 14, the data filtered through the detecting unit 1230 and the fourth mixer 1240 is made to minimize a zero velocity by cancelling out the noise shown in FIG. 13, whereby each step can be clearly recognized and processed. As a part that may be missed for an occurrence-possible specific step in case of depending on FIG. 13 is compensated for, accurate data can be calculated.

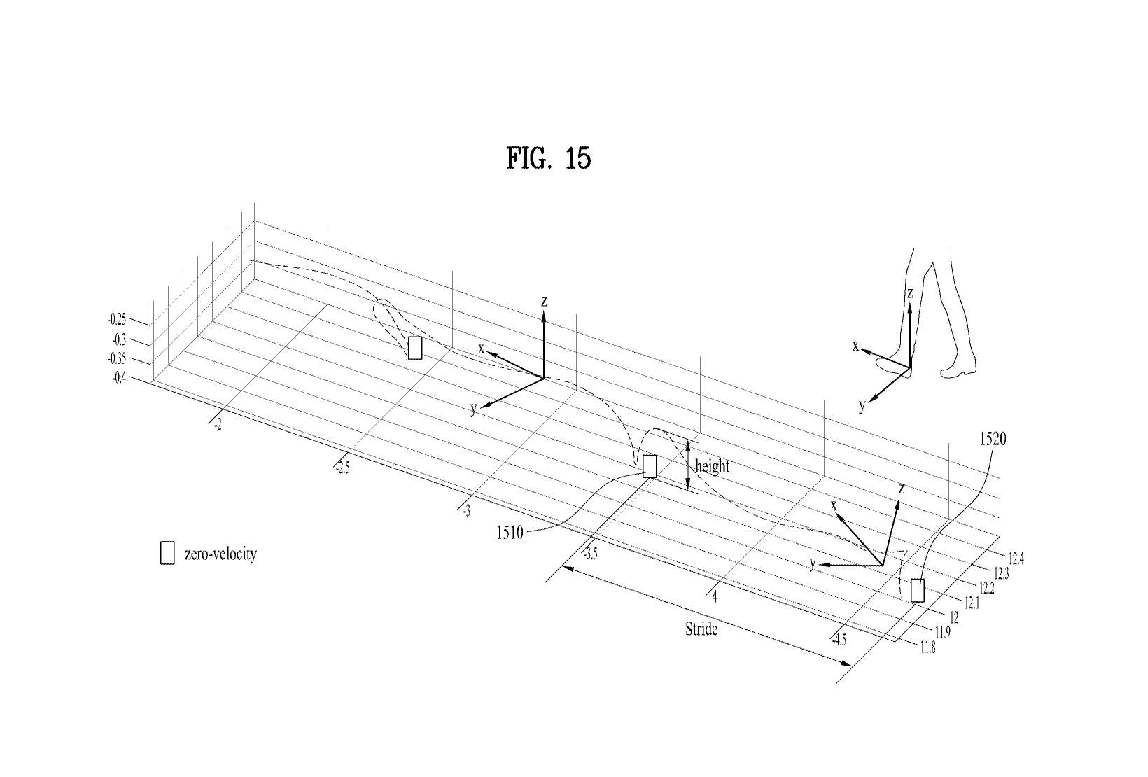

Therefore, according to FIG. 14, as a zero velocity for motion data (i.e., a motion on x-, y- and z-axis) of a smart shoe wearer is minimized, all steps can be accurately calculated. Based on this, according to the present invention including PDR scheme, foot angle data or foot angle correction data can be calculated easily and accurately. Hence, as shown in FIG. 15, wearer's moving path, moving velocity, moving direction stride and height and the like can be calculated accurately and easily. Thus, in comparison with a case that correction is required due to errors, which are cumulated because a zero velocity of each step cannot be obtained accurately using the PDR sensor or the inertia sensor only, efficiency of a system can be raised and power consumption can be reduced. Moreover, in case of using PDR sensor data only, wireless position measurement correction is necessary based on WiFi, Bluetooth and the like. Yet, if pressure sensor data is used as well, data can be sensed more accurately without using such a wireless position measurement scheme.

With respect to the stride or height, in case of hiking, using a building staircase or the like, a pressure sensor and the like are used for altitude. In this case, an ambient pressure abruptly fluctuates due to weather change, wind and the like. In case of using a staircase, a pressure changes considerably due to other factors such as a closed/open window or door and the like. Thus, accurate data sensing is impossible, and reliability of the sensed data is low. On the contrary, according to the present invention, by minimizing a zero velocity based on sensing data of a simple pressure sensor (or switch), data can be calculated easily and accurately without a pressure sensor or other configurations.

Such a tracking data processing algorithm according to the present invention can measure wearer's calorie consumption amount, weight change and the like by being used for a wearer's exercise information tracking and management service and provide a navigation or scheduling service by automatically recognizing bike riding, walking, running and the like. Moreover, by a tracking data processing algorithm according to the present invention, various services including a wearer's (soldier's, etc.) walking posture tracking and management service, an indoor navigation service for a mart, a library, a public institute and the like, an outdoor bicycle/walking navigation accuracy correction service, a workrate measurement and management service using walking zone tracking history management, stride, height and the like, a wearer tracking management service in a GPS/WiFi unavailable area, and the like can be provided.

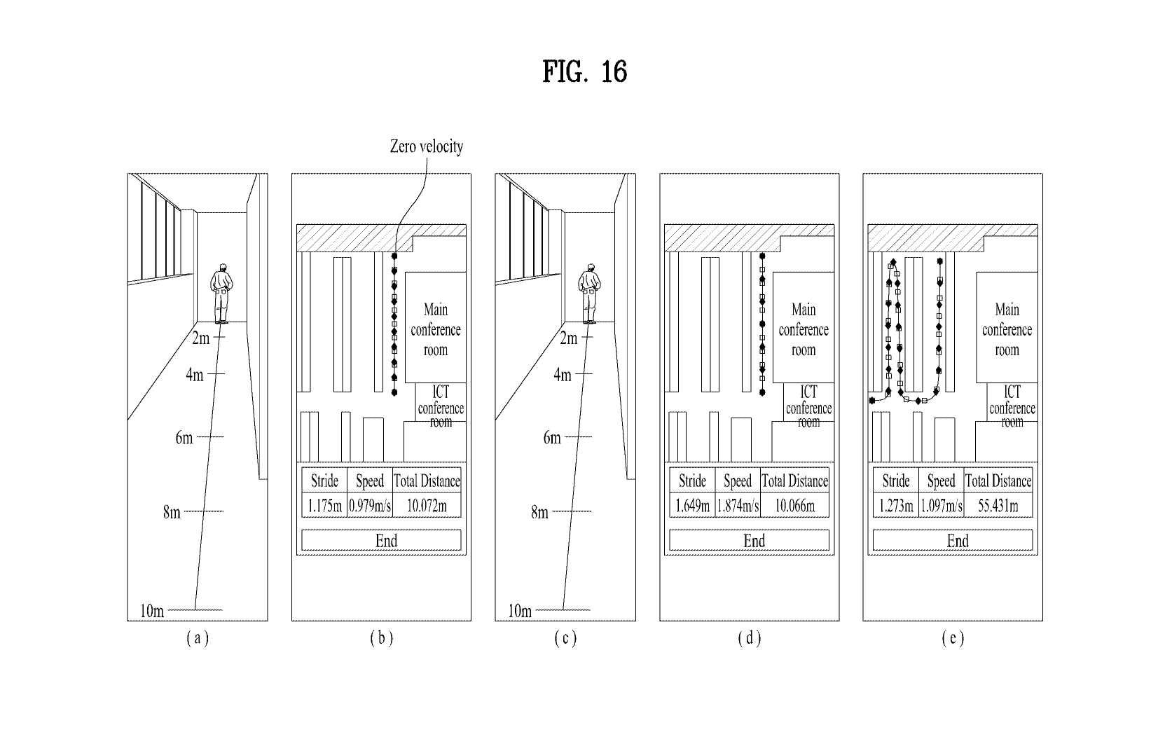

FIG. 16 is a diagram of a UX for one example of a service scenario according to the aforementioned present invention.

FIG. 16(a) shows a case of walking in a moving distance of 10 m at an average velocity, and FIG. 16(b) shows UX of data obtained through a tracking data processing unit in FIG. 16(a). Referring to FIG. 16(b), it can be observed that the data obtained through the tracking data processing unit for the moving distance ‘10 m’ in FIG. 16(a) is 10.072 m.

FIG. 16(c) shows a case of walking in a moving distance of 10 m at a high velocity of race walking, and FIG. 16(d) shows UX of data obtained through a tracking data processing unit in FIG. 16(c). Referring to FIG. 16(d), it can be observed that the data obtained through the tracking data processing unit for the moving distance ‘10 m’ in FIG. 16(c) is 10.066 m.

Moreover, FIG. 16(e) shows a UX for stride, velocity and total distance data cumulatively obtained for predetermined duration through a tracking data processing unit.

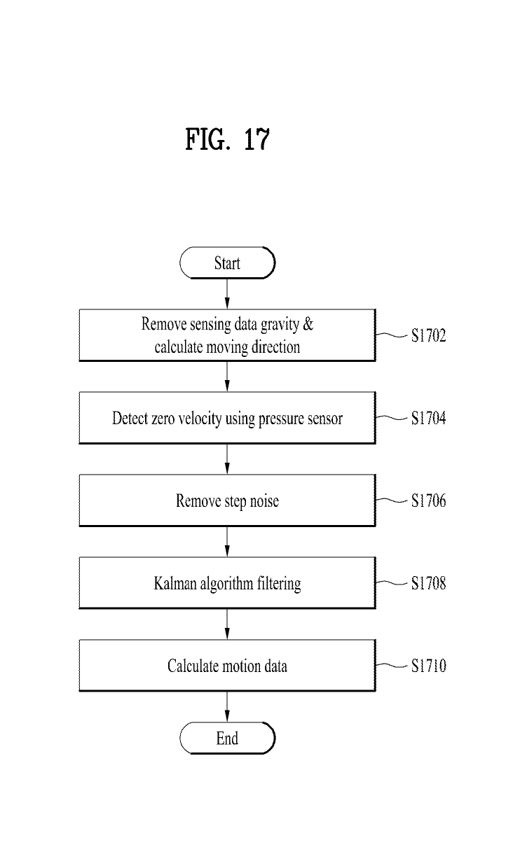

FIG. 17 is a flowchart of a data processing method in a smart shoe system according to the present invention.

A method of processing data in a smart shoe according to one embodiment of the present invention includes the steps of collecting sensing data from sensors, obtaining motion data from the collected sensing data, detecting zero velocity data of the motion data based on sensing data of a pressure sensor sensing a pressure of the smart shoe among the sensors by being switched by a step unit, removing step noise of the motion data based on the detected zero velocity data, filtering the step noise removed motion data, and processing motion data of the smart shoe based on the filtered motion data and a predefined threshold.

Referring to FIG. 17, a tracking data processing unit of a smart shoe system receives sensing data from one or more first sensors [S1702], and detects zero velocity data by receiving data sensed based on an operation of a second sensor [S1704]. Here, the first sensors include the first sensor (acceleration sensor) and the second sensor (gyro sensor) of FIG. 12 for example. Moreover, the second sensor includes the third sensor (pressure sensor) of FIG. 12.

The tracking data processing unit removes step noise of the sensing data received from the first sensors based on the detected zero velocity data [S1706]. The step noise means the noise 1310 shown in FIG. 13. Removing the step noise indicates the processing shown in FIG. 14.

The tracking data processing unit filters the step noise removed sensing data [S1708].

The tracking data processing unit obtains motion data of the smart shoe based on the filtered sensing data and a predefined threshold [S1710]. Here, the predefined threshold may indicate a value by data normalization according to filtering in the filter unit. Thus, if data is normalized, it can be helpful for data management and the like.

### MODE FOR INVENTION

According to each of the aforementioned various embodiments of the present invention or combinations thereof, battery efficiency is improved by minimizing power consumption despite wearer's motion sensing data collection and analysis through a new sensor module, whereby the inconvenience of frequent battery replacements and the like is resolved. By proposing a motion sensing algorithm based on sensing data collected by the sensor module, accuracy is improved in comparison with a related art motion sensing algorithm, whereby reliability of the smart shoe can be raised.

It will be apparent to those skilled in the art that various modifications and variations can be made therein without departing from the spirit and scope of the invention.

This description is intended to be illustrative, and not to limit the scope of the claims. Thus, it is intended that the present invention covers the modifications and variations of this invention provided they come within the scope of the appended claims and their equivalents.

### INDUSTRIAL APPLICABILITY

As the present invention relates to a smart shoe and technology thereof is applicable to digital industry overall, the present invention has industrial applicability.

What is claimed is:

1. A smart shoe, comprising:
a sensor unit including an acceleration sensor, a gyro sensor and a pressure sensor sensing a pressure of the smart shoe by being switched by a step unit; and
a data processing unit obtaining and processing motion data of the smart shoe based on sensing data of the sensor unit,
wherein the data processing unit is configured to:
remove step noise of the motion data of the smart shoe based on acceleration sensor data sensed through the acceleration sensor and gyro sensor data sensed through the gyro sensor by referring to zero velocity data detected from pressure sensor data sensed through the pressure sensor,
filter the step noise removed motion data, and
process the motion data of the smart shoe based on the filtered motion data and a predefined first threshold.

2. The smart shoe of claim 1, wherein the sensor unit is further configured to perform a sensing operation by being supplied with power only when the pressure sensor is turned on by the pressure.

3. The smart shoe of claim 2, wherein data processing unit is further configured to obtain the motion data including at least one of a moving distance, a moving velocity or a moving direction of the smart shoe based on sensor data received from the sensor unit.

4. The smart shoe of claim 3, wherein the data processing unit is further configured to:
remove the step noise by correcting moving velocity data in the motion data, and
process moving direction data in the motion data by referring to moving direction data obtained by calculating the moving direction of the smart shoe from the gyro sensor data and moving direction data in the filtered motion data.

5. The smart shoe of claim 1, wherein the data processing unit is further configured to process the motion data based on Kalman filter and PDR algorithm.

6. The smart shoe of claim 3, wherein the data processing unit is further configured to obtain at least one of stride data and height data of the smart shoe from the motion data and wherein the stride data and the height data are obtained based on the moving velocity data, the moving distance data and the moving direction data.

7. A smart shoe system, comprising:
a smart shoe including an acceleration sensor, a gyro sensor and a pressure sensor sensing a pressure of the smart shoe by being switched by a step unit; and
a mobile terminal including a data processing unit receiving sensing data of the smart shoe sensors, the mobile terminal processing motion data of the smart shoe based on the received pressure sensor sensing data,
wherein the data processing unit is configured to:
detect zero velocity data from the pressure sensing data in the received sensing data,
remove step noise of moving speed data generated from the acceleration sensor sensing data and the gyro sensor sensing data based on the detected zero velocity data, and
obtain motion data of the smart shoe based on the step noise removed moving velocity data.

8. A method of processing data in a smart shoe, comprising:
collecting sensing data from sensors;
obtaining motion data from the collected sensing data;
detecting zero velocity data of the motion data based on sensing data of a pressure sensor sensing a pressure of the smart shoe by being switched by a step unit among the sensors;
removing step noise of the motion data based on the detected zero velocity data;
filtering the step noise removed motion data; and
processing motion data of the smart shoe based on the filtered motion data and a predefined threshold.

9. The method of claim 8, the collecting the sensing data, comprising performing a sensing operation by being supplied with power only when the pressure sensor is turned on by the pressure.

10. The method of claim 9, wherein the motion data is obtained in a manner of including at least one of a moving distance, a moving velocity or a moving direction of the smart shoe based on sensor data received from the sensor unit.

11. The method of claim 10, wherein the removing the step noise is performed on moving velocity data in the motion data.

12. The method of claim 10, wherein moving direction data of the professed motion data is determined by referring to a first moving direction data obtained by calculating the moving direction of the smart shoe from gyro sensor data among the sensors and the filtered motion data.

13. The method of claim 8, wherein the motion data is processed based on Kalman filter and PDR algorithm.

14. The method of claim 10, wherein the motion data further comprises at least one of stride data and height data of the smart shoe and wherein the stride data and the height data are obtained based on the moving velocity data, the moving distance data and the moving direction data.
